(19) United States
(12) Patent Application Publication
(10) Pub. No.: US 2017/0129344 A1
(43) Pub. Date: May 11, 2017

(54) METHODS AND APPARATUS FOR THERMAL DISSIPATION IN VEHICLE PADS FOR WIRELESS POWER TRANSFER APPLICATIONS

(71) Applicant: QUALCOMM Incorporated, San Diego, CA (US)

(72) Inventors: Simon Peter Islinger, Munich (DE); Steven Daniel Niederhauser, Munich (DE); Jonathan Beaver, Auckland (NZ); Chang-Yu Huang, Auckland (NZ); Mickel Bipin Budhia, Auckland (NZ); Nicholas Athol Keeling, Auckland (NZ); Hao Hao, Auckland (NZ); Michael Le Gallais Kissin, Auckland (NZ); Rafal Krzysztof Scibor, Munich (DE); Johan Gabriel Samuelsson, Aying (DE)

(21) Appl. No.: 14/934,625

(22) Filed: Nov. 6, 2015

(51) Int. Cl. B60L 11/18; H02J 5/00

(52) U.S. Cl. CPC B60L 11/182; H02J 5/005

(57) ABSTRACT

Methods and apparatuses for thermal dissipation in vehicle pads for wireless power transfer applications are provided. In some implementations, an apparatus for wirelessly receiving charging power is provided. The apparatus comprises at least one receive coil configured to wirelessly receive the charging power. The apparatus further comprises a plurality of electrical components configured to convert the charging power to a direct current. The apparatus further comprises a primary heat sink comprising a plurality of fins configured to dissipate heat generated by the plurality of electrical components. The plurality of fins are disposed adjacent to the plurality of electrical components. The apparatus further comprises at least one thermally conductive structure configured to physically connect at least some of the plurality of electrical components to the primary heat sink.

### FIELD

The present disclosure relates generally to wireless power transfer, and more specifically to methods and apparatuses for thermal dissipation in vehicle pads for wireless power transfer applications.

### BACKGROUND

Inductive power transfer (IPT) systems provide one example of wireless transfer of energy. In IPT systems, a primary power device (or “transmitter”) transmits power wirelessly to a secondary power device (or “receiver”). Each of the transmitter and receiver includes an inductive coupler, typically a single or multi-coil arrangement of windings comprising electric current conveying materials, such as Litz wire. An alternating current passing through a primary coupler produces an alternating magnetic field. When a secondary coupler is placed in proximity to the primary coupler, the alternating magnetic field induces an electromotive force (EMF) in the secondary coupler according to Faraday's law, thereby wirelessly transferring power to the receiver.

Vehicle pads for inductively receiving power may receive relatively large amounts of power to charge and/or power the vehicle. Receiving such large amounts of power generates heat. Thus, vehicle pads may require the ability to dissipate large amounts of thermal energy from electrical resistance heating of internal electrical components in order to maintain acceptable operating temperatures. As such, methods and apparatuses for thermal dissipation in vehicle pads for wireless power transfer applications are desirable.

### SUMMARY

In some implementations, apparatus for wirelessly receiving charging power is provided. The apparatus comprises at least one receive coil configured to wirelessly receive charging power. The apparatus further comprises a plurality of electrical components configured to convert the charging power to a direct current. The apparatus further comprises a primary heat sink comprising a plurality of fins configured to dissipate heat generated by the plurality of electrical components. The plurality of fins are disposed adjacent to the plurality of electrical components. The apparatus further comprises at least one thermally conductive structure configured to physically connect at least some of the plurality of electrical components to the primary heat sink.

Some other implementations provide a method for wirelessly receiving charging power. The method comprises wirelessly receiving charging power via at least one receive coil. The method comprises converting the charging power to a direct current via a plurality of electrical components. The method comprises dissipating heat generated by the plurality of electrical components via a primary heat sink comprising a plurality of fins. The plurality of electrical components disposed adjacent to the plurality of fins and at least some of the plurality of electrical components physically connected to the primary heat sink.

Yet other implementations provide an apparatus for wirelessly receiving charging power. The apparatus comprises means for wirelessly receive charging power. The apparatus further comprises a plurality of means for converting the charging power to a direct current. The apparatus further comprises means for dissipating heat generated by the plurality of means for converting the charging power to the direct current, the means for dissipating heat comprising a plurality of fins disposed adjacent to the means for converting the charging power to the direct current. The apparatus further comprises means for thermally connecting at least some of the plurality of means for converting the charging power to the direct current to the means for dissipating heat.

Yet other implementations provide apparatus for wirelessly receiving charging power on a vehicle. The apparatus comprises at least one receive coil configured to wirelessly receive charging power. The apparatus further comprises a plurality of electrical components configured to convert the charging power to a direct current. The apparatus further comprises a primary heat sink configured to dissipate heat generated by the plurality of electrical components. The apparatus further comprises a controller configured to adjust an amount of the charging power drawn by the at least one receive coil based on a temperature of the primary heat sink.

Yet other implementations provide a method for wirelessly receiving charging power at a vehicle. The method comprises wirelessly receiving charging power via at least one receive coil. The method comprises converting the charging power to a direct current via a plurality of electrical components. The method comprises dissipating heat generated by the plurality of electrical components via a primary heat sink. The method comprises adjusting an amount of the charging power drawn by the at least one receive coil based on a temperature of the primary heat sink.

### BRIEF DESCRIPTION OF THE DRAWINGS

FIG. 1 illustrates a wireless power transfer system for charging an electric vehicle, in accordance with some implementations.

FIG. 2 is a schematic diagram of core components of a wireless power transfer system similar to that previously discussed in connection with FIG. 1, in accordance with some implementations.

FIG. 3 is a functional block diagram showing core and ancillary components of the wireless power transfer system of FIG. 1.

FIG. 4 is a schematic diagram of a vehicle including a vehicle pad configured to receive wireless power while stationary over a base pad, in accordance with some implementations.

FIG. 5 is a schematic diagram of a vehicle including a vehicle pad configured to receive wireless power while moving over a wireless power transfer backbone, in accordance with some implementations.

FIG. 6 is an exploded isometric diagram of the vehicle pad from FIG. 4 configured to receive wireless power and dissipate increased levels of thermal energy, in accordance with some implementations.

FIG. 7 is an isometric top view of the vehicle pad of FIG. 6.

FIG. 8 is an isometric bottom view of the vehicle pad of FIG. 6.

FIG. 9 is an exploded isometric diagram of a portion of the vehicle pad of FIG. 6 showing a Litz wire termination socket configured to dissipate increased levels of thermal energy, in accordance with some implementations.

FIG. 10 is an isometric diagram of the portion of the vehicle pad of FIG. 6 shown in FIG. 9 in an assembled state.

FIG. 11 is a thermal contour diagram of a primary heat sink of the vehicle pad of FIG. 6 during operation, in accordance with some implementations.

FIG. 12 is a diagram illustrating air velocity around the primary heat sink of the vehicle pad of FIG. 6 during operation, in accordance with some implementations.

FIG. 13 is a flowchart depicting a method for wirelessly receiving charging power, in accordance with some implementations.

FIG. 14 is a flowchart depicting another method for wirelessly receiving charging power at a vehicle, in accordance with some implementations.

### DETAILED DESCRIPTION

The detailed description set forth below in connection with the appended drawings is intended as a description of implementations and is not intended to represent the only implementations. The detailed description includes specific details for the purpose of providing a thorough understanding of the implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include, besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

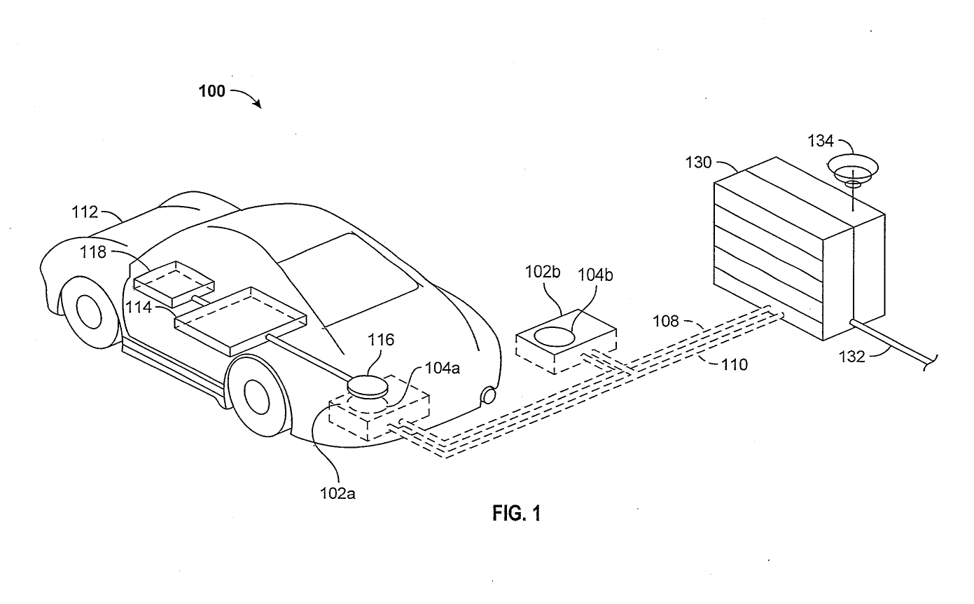

FIG. 1 is a diagram of a wireless power transfer system 100 for charging an electric vehicle, in accordance with some implementations. The wireless power transfer system 100 enables charging of an electric vehicle 112 while the electric vehicle 112 is parked so as to efficiently couple with a base wireless charging system 102a. Spaces for two electric vehicles are illustrated in a parking area to be parked over corresponding base wireless charging systems 102a and 102b. In some implementations, a local distribution center 130 may be connected to a power backbone 132 and configured to provide an alternating current (AC) or a direct current (DC) supply through a power link 110 to the base wireless charging systems 102a and 102b. Each of the base wireless charging systems 102a and 102b also includes a base coupler 104a and 104b, respectively, for wirelessly transferring power. In some other implementations (not shown in FIG. 1), base couplers 104a or 104b may be stand-alone physical units and are not part of the base wireless charging system 102a or 102b.

The electric vehicle 112 may include a battery unit 118, an electric vehicle coupler 116, and an electric vehicle wireless charging unit 114. The electric vehicle wireless charging unit 114 and the electric vehicle coupler 116 constitute the electric vehicle wireless charging system. In some diagrams shown herein, the electric vehicle wireless charging unit 114 is also referred to as the vehicle charging unit (VCU). The electric vehicle coupler 116 may interact with the base coupler 104a for example, via a region of the electromagnetic field generated by the base coupler 104a.

In some implementations, the electric vehicle coupler 116 may receive power when the electric vehicle coupler 116 is located in an electromagnetic field produced by the base coupler 104a. The field may correspond to a region where energy output by the base coupler 104a may be captured by the electric vehicle coupler 116. For example, the energy output by the base coupler 104a may be at a level sufficient to charge or power the electric vehicle 112. In some cases, the field may correspond to a “near-field” of the base coupler 104a. The near-field may correspond to a region in which there are strong reactive fields resulting from the currents and charges in the base coupler 104a that do not radiate power away from the base coupler 104a. In some cases the near-field may correspond to a region that is within about ½π of a wavelength of the frequency of the electromagnetic field produced by the base coupler 104a distant from the base coupler 104a, as will be further described below.

Local distribution center 130 may be configured to communicate with external sources (e.g., a power grid) via a communication backhaul 134, and with the base wireless charging system 102a via a communication link 108.

In some implementations the electric vehicle coupler 116 may be aligned with the base coupler 104a and, therefore, disposed within a near-field region simply by the electric vehicle operator positioning the electric vehicle 112 such that the electric vehicle coupler 116 is sufficiently aligned relative to the base coupler 104a. Alignment may be considered sufficient when an alignment error has fallen below a tolerable value. In other implementations, the operator may be given visual and/or auditory feedback to determine when the electric vehicle 112 is properly placed within a tolerance area for wireless power transfer. In yet other implementations, the electric vehicle 112 may be positioned by an autopilot system, which may move the electric vehicle 112 until the sufficient alignment is achieved. This may be performed automatically and autonomously by the electric vehicle 112 with or without driver intervention. This may be possible for an electric vehicle 112 that is equipped with a servo steering, radar sensors (e.g., ultrasonic sensors), and intelligence for safely maneuvering and adjusting the electric vehicle. In still other implementations, the electric vehicle 112 and/or the base wireless charging system 102a may have functionality for mechanically displacing and moving the couplers 116 and 104a, respectively, relative to each other to more accurately orient or align them and develop sufficient and/or otherwise more efficient coupling there between.

The base wireless charging system 102a may be located in a variety of locations. As non-limiting examples, some suitable locations include a parking area at a home of the electric vehicle 112 owner, parking areas reserved for electric vehicle wireless charging modeled after conventional petroleum-based filling stations, and parking lots at other locations such as shopping centers and places of employment.

Charging electric vehicles wirelessly may provide numerous benefits. For example, charging may be performed automatically, virtually without driver intervention or manipulation thereby improving convenience to a user. There may also be no exposed electrical contacts and no mechanical wear out, thereby improving reliability of the wireless power transfer system 100. Safety may be improved since manipulations with cables and connectors may not be needed and there may be no cables, plugs, or sockets to be exposed to moisture in an outdoor environment. In addition, there may also be no visible or accessible sockets, cables, or plugs, thereby reducing potential vandalism of power charging devices. Further, since the electric vehicle 112 may be used as distributed storage devices to stabilize a power grid, a convenient docking-to-grid solution may help to increase availability of vehicles for vehicle-to-grid (V2G) operation.

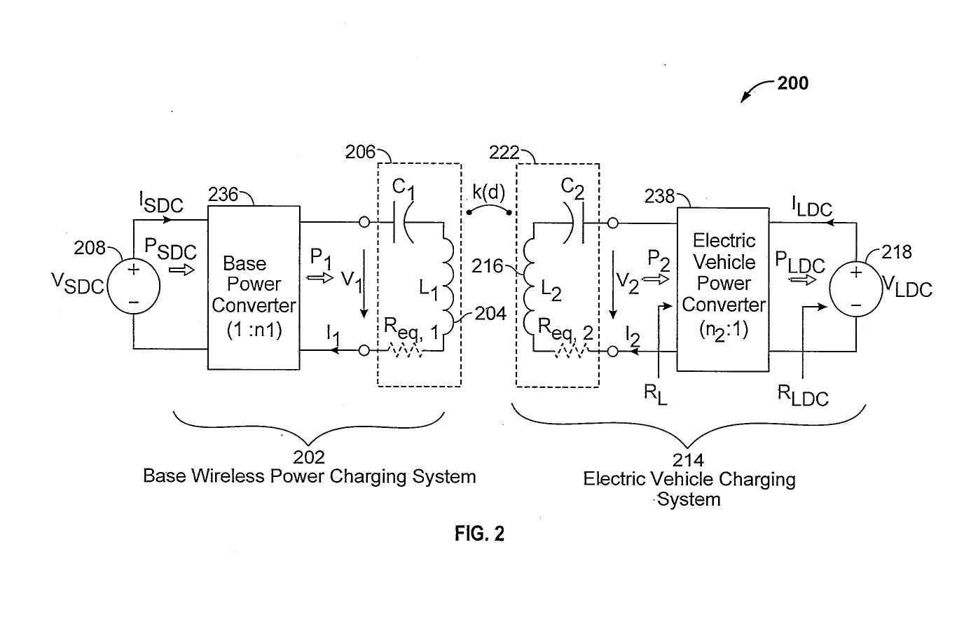

FIG. 2 is a schematic diagram of core components of a wireless power transfer system 200 similar to that previously discussed in connection with FIG. 1, in accordance with some implementations. The wireless power transfer system 200 may include a base resonant circuit 206 including a base coupler 204 having an inductance L₁. The wireless power transfer system 200 further includes an electric vehicle resonant circuit 222 including an electric vehicle coupler 216 having an inductance L₂. Implementations described herein may use capacitively loaded conductor loops (i.e., multi-turn coils) forming a resonant structure that is capable of efficiently coupling energy from a primary structure (transmitter) to a secondary structure (receiver) via a magnetic or electromagnetic near-field if both the transmitter and the receiver are tuned to a common resonant frequency. The coils may be used for the electric vehicle coupler 216 and the base coupler 204. Using resonant structures for coupling energy may be referred to as “magnetically coupled resonance,” “electromagnetically coupled resonance,” and/or “resonant induction.” The operation of the wireless power transfer system 200 will be described based on power transfer from a base coupler 204 to an electric vehicle 112 (not shown), but is not limited thereto. For example, as discussed above, energy may be also transferred in the reverse direction.

With reference to FIG. 2, a power supply 208 (e.g., AC or DC) supplies power P_{SDC} to the base power converter 236 as part of the base wireless power charging system 202 to transfer energy to an electric vehicle (e.g., electric vehicle 112 of FIG. 1). The base power converter 236 may include circuitry such as an AC-to-DC converter configured to convert power from standard mains AC to DC power at a suitable voltage level, and a DC-to-low frequency (LF) converter configured to convert DC power to power at an operating frequency suitable for wireless high power transfer. The base power converter 236 supplies power P₁ to the base resonant circuit 206 including tuning capacitor C₁ in series with base coupler 204 to emit an electromagnetic field at the operating frequency. The series-tuned resonant circuit 206 should be construed as an example. In another implementation, the capacitor C₁ may be coupled with the base coupler 204 in parallel. In yet other implementations, tuning may be formed of several reactive elements in any combination of parallel or series topology. The capacitor C₁ may be provided to form a resonant circuit with the base coupler 204 that resonates substantially at the operating frequency. The base coupler 204 receives the power P₁ and wirelessly transmits power at a level sufficient to charge or power the electric vehicle. For example, the level of power provided wirelessly by the base coupler 204 may be on the order of kilowatts (kW) (e.g., anywhere from 1 kW to 110 kW, although actual levels may be or higher or lower).

The base resonant circuit 206 (including the base coupler 204 and tuning capacitor C₁) and the electric vehicle resonant circuit 222 (including the electric vehicle coupler 216 and tuning capacitor C₂) may be tuned to substantially the same frequency. The electric vehicle coupler 216 may be positioned within the near-field of the base coupler and vice versa, as further explained below. In this case, the base coupler 204 and the electric vehicle coupler 216 may become coupled to one another such that power may be transferred wirelessly from the base coupler 204 to the electric vehicle coupler 216. The series capacitor C₂ may be provided to form a resonant circuit with the electric vehicle coupler 216 that resonates substantially at the operating frequency. The series-tuned resonant circuit 222 should be construed as examples. In another implementation, the capacitor C₂ may be coupled with the electric vehicle coupler 216 in parallel. In yet other implementations, the electric vehicle resonant circuit 222 may be formed of several reactive elements in any combination of parallel or series topology. Element k(d) represents the mutual coupling coefficient resulting at coil separation “d”. Equivalent resistances R_{eq,1} and R_{eq,2} represent the losses that may be inherent to the base and electric vehicle couplers 204 and 216 and the tuning (anti-reactance) capacitors C₁ and C₂, respectively. The electric vehicle resonant circuit 222, including the electric vehicle coupler 216 and capacitor C₂, receives and provides the power P₂ to an electric vehicle power converter 238 of an electric vehicle charging system 214.

The electric vehicle power converter 238 may include, among other things, a LF-to-DC converter configured to convert power at an operating frequency back to DC power at a voltage level of the load 218 that may represent the electric vehicle battery unit. The electric vehicle power converter 238 may provide the converted power P_{LDC} to the load 218. The power supply 208, base power converter 236, and base coupler 204 may be stationary and located at a variety of locations as discussed above. The electric vehicle load 218 (e.g., the electric vehicle battery unit), electric vehicle power converter 238, and electric vehicle coupler 216 may be included in the electric vehicle charging system 214 that is part of the electric vehicle (e.g., electric vehicle 112) or part of its battery pack (not shown). The electric vehicle charging system 214 may also be configured to provide power wirelessly through the electric vehicle coupler 216 to the base wireless power charging system 202 to feed power back to the grid. Each of the electric vehicle coupler 216 and the base coupler 204 may act as transmit or receive couplers based on the mode of operation.

While not shown, the wireless power transfer system 200 may include a load disconnect unit (LDU) (not shown) to safely disconnect the electric vehicle load 218 or the power supply 208 from the wireless power transfer system 200. For example, in case of an emergency or system failure, the LDU may be triggered to disconnect the load from the wireless power transfer system 200. The LDU may be provided in addition to a battery management system for managing charging to a battery, or it may be part of the battery management system.

Further, the electric vehicle charging system 214 may include switching circuitry (not shown) for selectively connecting and disconnecting the electric vehicle coupler 216 to the electric vehicle power converter 238. Disconnecting the electric vehicle coupler 216 may suspend charging and also may change the “load” as “seen” by the base wireless power charging system 202 (acting as a transmitter), which may be used to “cloak” the electric vehicle charging system 214 (acting as the receiver) from the base wireless charging system 202. The load changes may be detected if the transmitter includes a load sensing circuit. Accordingly, the transmitter, such as the base wireless charging system 202, may have a mechanism for determining when receivers, such as the electric vehicle charging system 214, are present in the near-field coupling mode region of the base coupler 204 as further explained below.

As described above, in operation, during energy transfer towards an electric vehicle (e.g., electric vehicle 112 of FIG. 1), input power is provided from the power supply 208 such that the base coupler 204 generates an electromagnetic field for providing the energy transfer. The electric vehicle coupler 216 couples to the electromagnetic field and generates output power for storage or consumption by the electric vehicle 112. As described above, in some implementations, the base resonant circuit 206 and electric vehicle resonant circuit 222 are configured and tuned according to a mutual resonant relationship such that they are resonating nearly or substantially at the operating frequency. Transmission losses between the base wireless power charging system 202 and electric vehicle charging system 214 are minimal when the electric vehicle coupler 216 is located in the near-field coupling mode region of the base coupler 204 as further explained below.

As stated, an efficient energy transfer occurs by transferring energy via a magnetic near-field rather than via electromagnetic waves in the far field, which may involve substantial losses due to radiation into space. When in the near-field, a coupling mode may be established between the transmit coupler and the receive coupler. The space around the couplers where this near-field coupling may occur is referred to herein as a near-field coupling mode region.

While not shown, the base power converter 236 and the electric vehicle power converter 238 if bidirectional may both include, for the transmit mode, an oscillator, a driver circuit such as a power amplifier, a filter and matching circuit, and for the receive mode a rectifier circuit. The oscillator may be configured to generate a desired operating frequency, which may be adjusted in response to an adjustment signal. The oscillator signal may be amplified by a power amplifier with an amplification amount responsive to control signals. The filter and matching circuit may be included to filter out harmonics or other unwanted frequencies and match the impedance as presented by the resonant circuits 206 and 222 to the base and electric vehicle power converters 236 and 238, respectively. For the receive mode, the base and electric vehicle power converters 236 and 238 may also include a rectifier and switching circuitry.

The electric vehicle coupler 216 and base coupler 204 as described throughout the disclosed implementations may be referred to or configured as “conductor loops”, and more specifically, “multi-turn conductor loops” or coils. The base and electric vehicle couplers 204 and 216 may also be referred to herein or be configured as “magnetic” couplers. The term “coupler” is intended to refer to a component that may wirelessly output or receive energy for coupling to another “coupler.”

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency.

A resonant frequency may be based on the inductance and capacitance of a resonant circuit (e.g. resonant circuit 206) including a coupler (e.g., the base coupler 204 and capacitor C₂) as described above. As shown in FIG. 2, inductance may generally be the inductance of the coupler, whereas, capacitance may be added to the coupler to create a resonant structure at a desired resonant frequency. Accordingly, for larger size couplers using larger diameter coils exhibiting larger inductance, the value of capacitance needed to produce resonance may be lower. Inductance may also depend on a number of turns of a coil. Furthermore, as the size of the coupler increases, coupling efficiency may increase. This is mainly true if the size of both base and electric vehicle couplers increase. Furthermore a resonant circuit including a coupler and tuning capacitor may be designed to have a high quality (Q) factor to improve energy transfer efficiency. For example, the Q factor may be 300 or greater.

As described above, according to some implementations, coupling power between two couplers that are in the near-field of one another is disclosed. As described above, the near-field may correspond to a region around the coupler in which mainly reactive electromagnetic fields exist. If the physical size of the coupler is much smaller than the wavelength, inversely proportional to the frequency, there is no substantial loss of power due to waves propagating or radiating away from the coupler. Near-field coupling-mode regions may correspond to a volume that is near the physical volume of the coupler, typically within a small fraction of the wavelength. According to some implementations, magnetic couplers, such as single and multi-turn conductor loops, are preferably used for both transmitting and receiving since handling magnetic fields in practice is easier than electric fields because there is less interaction with foreign objects, e.g., dielectric objects and the human body. Nevertheless, “electric” couplers (e.g., dipoles and monopoles) or a combination of magnetic and electric couplers may be used.

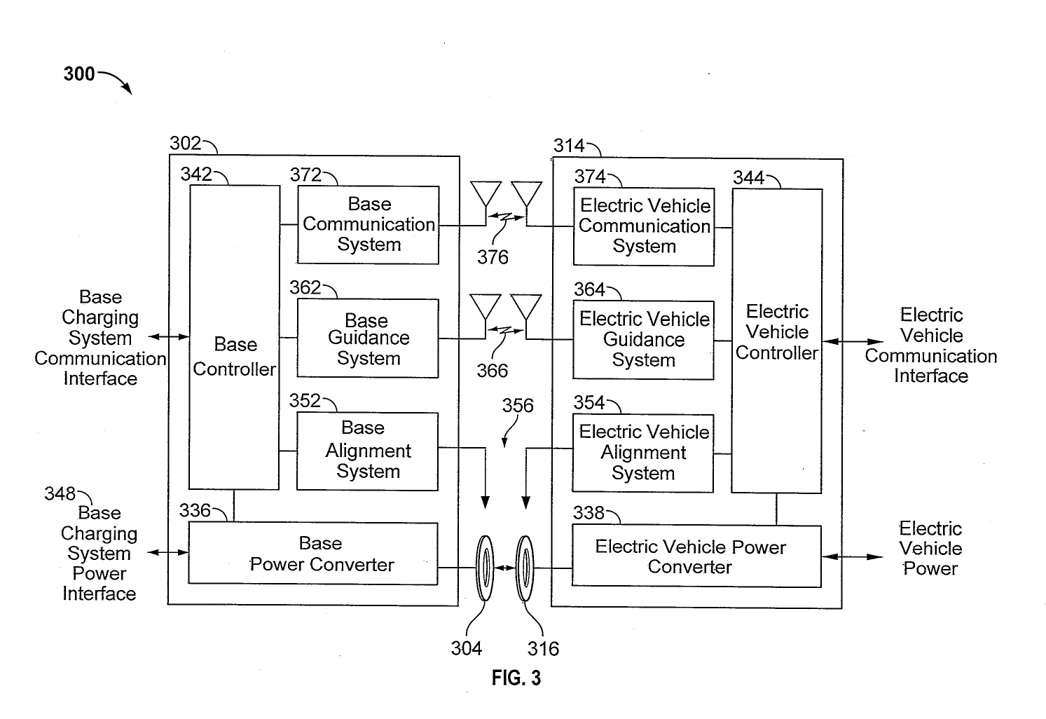

FIG. 3 is a functional block diagram showing components of wireless power transfer system 300, which may be employed in wireless power transfer system 100 of FIG. 1 and/or that wireless power transfer system 200 of FIG. 2 may be part of. The wireless power transfer system 300 illustrates a communication link 376, a guidance link 366, using, for example, a magnetic field signal for determining a position or direction, and an alignment mechanism 356 capable of mechanically moving one or both of the base coupler 304 and the electric vehicle coupler 316. Mechanical (kinematic) alignment of the base coupler 304 and the electric vehicle coupler 316 may be controlled by the base alignment system 352 and the electric vehicle charging alignment system 354, respectively. The guidance link 366 may be capable of bi-directional signaling, meaning that guidance signals may be emitted by the base guidance system or the electric vehicle guidance system or by both. As described above with reference to FIG. 1, when energy flows towards the electric vehicle 112, in FIG. 3 a base charging system power interface 348 may be configured to provide power to a base power converter 336 from a power source, such as an AC or DC power supply (not shown). The base power converter 336 may receive AC or DC power via the base charging system power interface 348 to drive the base coupler 304 at a frequency near or at the resonant frequency of the base resonant circuit 206 with reference to FIG. 2. The electric vehicle coupler 316, when in the near-field coupling-mode region, may receive energy from the electromagnetic field to oscillate at or near the resonant frequency of the electric vehicle resonant circuit 222 with reference to FIG. 2. The electric vehicle power converter 338 converts the oscillating signal from the electric vehicle coupler 316 to a power signal suitable for charging a battery via the electric vehicle power interface.

The base wireless charging system 302 includes a base controller 342 and the electric vehicle charging system 314 includes an electric vehicle controller 344. The base controller 342 may provide a base charging system communication interface to other systems (not shown) such as, for example, a computer, a base common communication (BCC), a communications entity of the power distribution center, or a communications entity of a smart power grid. The electric vehicle controller 344 may provide an electric vehicle communication interface to other systems (not shown) such as, for example, an on-board computer on the vehicle, a battery management system, other systems within the vehicles, and remote systems.

The base communication system 372 and electric vehicle communication system 374 may include subsystems or modules for specific application with separate communication channels and also for wirelessly communicating with other communications entities not shown in the diagram of FIG. 3. These communications channels may be separate physical channels or separate logical channels. As non-limiting examples, a base alignment system 352 may communicate with an electric vehicle alignment system 354 through communication link 376 to provide a feedback mechanism for more closely aligning the base coupler 304 and the electric vehicle coupler 316, for example via autonomous mechanical (kinematic) alignment, by either the electric vehicle alignment system 352 or the base alignment system 352, or by both, or with operator assistance as described herein. Similarly, a base guidance system 362 may communicate with an electric vehicle guidance system 364 through communication link 376 and also using a guidance link 366 for determining a position or direction as needed to guide an operator to the charging spot and in aligning the base coupler 304 and electric vehicle coupler 316. In some implementations, communications link 376 may comprise a plurality of separate, general-purpose communication channels supported by base communication system 372 and electric vehicle communication system 374 for communicating other information between the base wireless charging system 302 and the electric vehicle charging system 314. This information may include information about electric vehicle characteristics, battery characteristics, charging status, and power capabilities of both the base wireless charging system 302 and the electric vehicle charging system 314, as well as maintenance and diagnostic data for the electric vehicle. These communication channels may be separate logical channels or separate physical communication channels such as, for example, WLAN, Bluetooth, zigbee, cellular, etc.

In some implementations, electric vehicle controller 344 may also include a battery management system (BMS) (not shown) that manages charge and discharge of the electric vehicle principal and/or auxiliary battery. As discussed herein, base guidance system 362 and electric vehicle guidance system 364 include the functions and sensors as needed for determining a position or direction, e.g., based on microwave, ultrasonic radar, or magnetic vectoring principles. Further, electric vehicle controller 344 may be configured to communicate with electric vehicle onboard systems. For example, electric vehicle controller 344 may provide, via the electric vehicle communication interface, position data, e.g., for a brake system configured to perform a semi-automatic parking operation, or for a steering servo system configured to assist with a largely automated parking (“park by wire”) that may provide more convenience and/or higher parking accuracy as may be needed in certain applications to provide sufficient alignment between base and electric vehicle couplers 304 and 316. Moreover, electric vehicle controller 344 may be configured to communicate with visual output devices (e.g., a dashboard display), acoustic/audio output devices (e.g., buzzer, speakers), mechanical input devices (e.g., keyboard, touch screen, and pointing devices such as joystick, trackball, etc.), and audio input devices (e.g., microphone with electronic voice recognition).

The wireless power transfer system 300 may include other ancillary systems such as detection and sensor systems (not shown). For example, the wireless power transfer system 300 may include sensors for use with systems to determine a position as required by the guidance system (362, 364) to properly guide the driver or the vehicle to the charging spot, sensors to mutually align the couplers with the required separation/coupling, sensors to detect objects that may obstruct the electric vehicle coupler 316 from moving to a particular height and/or position to achieve coupling, and safety sensors for use with systems to perform a reliable, damage free, and safe operation of the system. For example, a safety sensor may include a sensor for detection of presence of animals or children approaching the base and electric vehicle couplers 304, 316 beyond a safety radius, detection of metal objects located near or in proximity of the base or electric vehicle coupler (304, 316) that may be heated up (induction heating), and for detection of hazardous events such as incandescent objects near the base or electric vehicle coupler (304, 316).

The wireless power transfer system 300 may also support plug-in charging via a wired connection, for example, by providing a wired charge port (not shown) at the electric vehicle charging system 314. The electric vehicle charging system 314 may integrate the outputs of the two different chargers prior to transferring power to or from the electric vehicle. Switching circuits may provide the functionality as needed to support both wireless charging and charging via a wired charge port.

To communicate between the base wireless charging system 302 and the electric vehicle charging system 314, the wireless power transfer system 300 may use in-band signaling via base and electric vehicle couplers 304, 316 and/or out-of-band signaling via communications systems (372, 374), e.g., via an RF data modem (e.g., Ethernet over radio in an unlicensed band). The out-of-band communication may provide sufficient bandwidth for the allocation of value-add services to the vehicle user/owner. A low depth amplitude or phase modulation of the wireless power carrier may serve as an in-band signaling system with minimal interference.

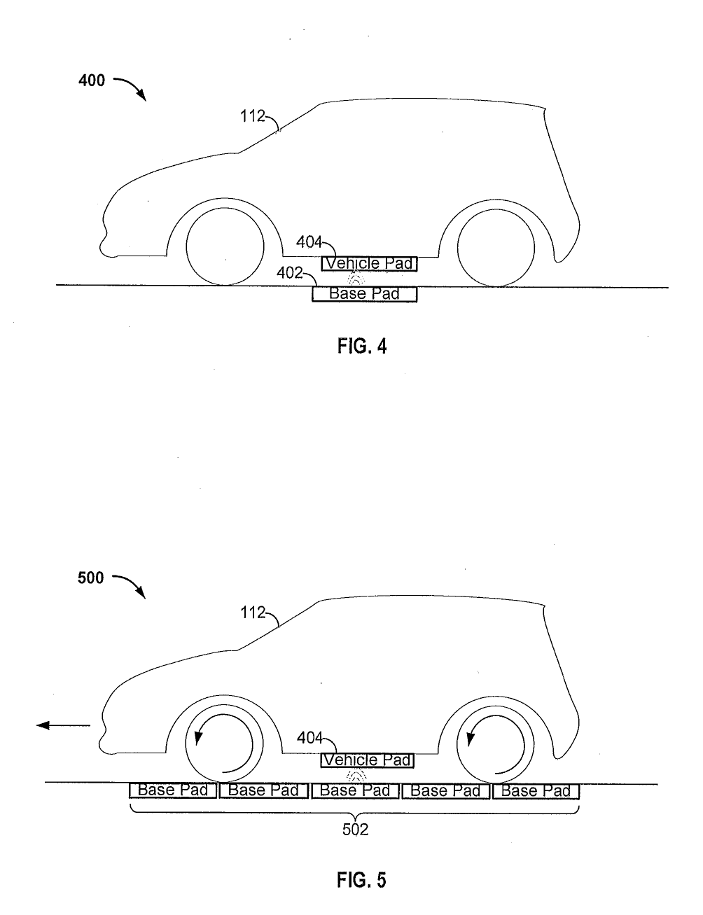

FIG. 4 is a schematic diagram 400 of a vehicle 112 including a vehicle pad 404 configured to receive wireless power while stationary over a base pad 402, in accordance with some implementations. FIG. 4 shows the vehicle pad 404 receiving charging or operating power from the base pad 402 via a wireless magnetic field, as shown by the curved lines.

FIG. 5 is a schematic diagram 500 of the vehicle 112 including the vehicle pad 404 configured to receive wireless power while moving over a wireless power transfer backbone 502, in accordance with some implementations. FIG. 5 shows the vehicle pad 404 receiving charging or operating power from the power backbone 502 comprising a plurality of base pads similar to those previously described in connection with FIG. 4. The vehicle pad 404 receives the wireless power via a wireless magnetic field while in motion, as shown by the curved lines and the arrows, respectively.

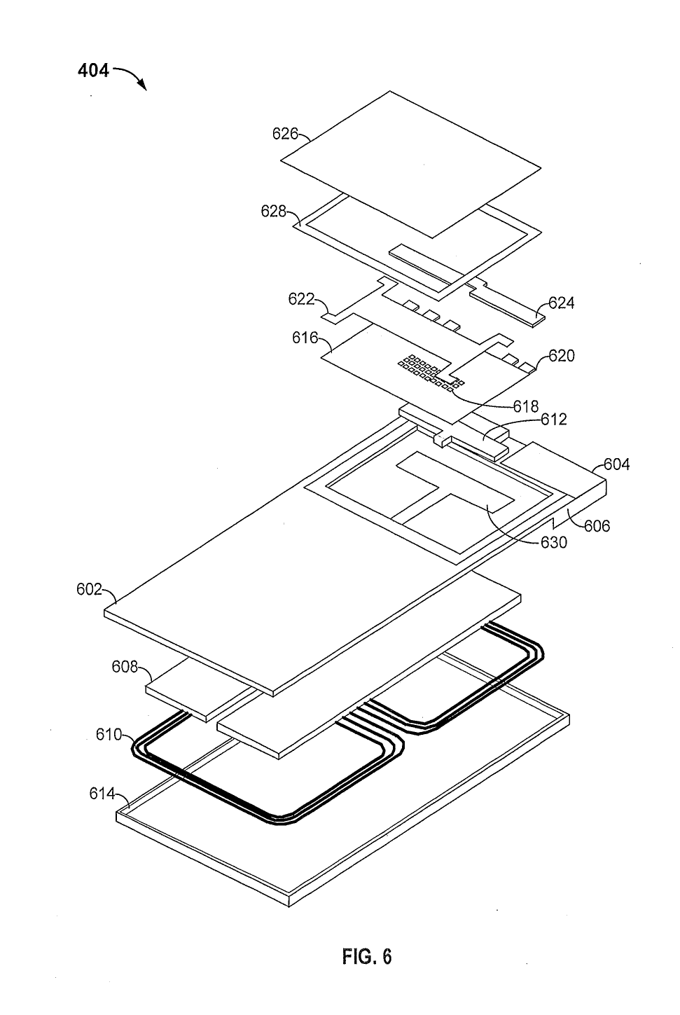

FIG. 6 is an exploded isometric diagram of the vehicle pad 404 from FIG. 4 configured to receive wireless power and dissipate increased levels of thermal energy, in accordance with some implementations. The vehicle pad 404 includes a primary heat sink 602, which in some implementations may comprise aluminum. However, the present disclosure is not so limited and the primary heat sink 602 may comprise any material with relatively high thermal conductivity (e.g., metals). The primary heat sink 602 functions as a heat sink for all electrical components within the vehicle pad 404. In some implementations, the primary heat sink 602 further includes cooling fins 604 to increase the surface area of the primary heat sink 602 and thus its ability to radiate heat away from the vehicle pad 404. The primary heat sink 602 may further comprise a recessed portion 606 configured to support at least a printed circuit board (PCB) 616 including power electrical components such as capacitors 618 and diodes 620, which may generate heat due to resistive losses. The cooling fins 604 may be located adjacent to the recessed portion 606 such that the diodes 620, which are responsible for a large portion of the heat generated in the vehicle pad 404, are also located physically adjacent to the cooling fins 604. This physical arrangement provides a short, thermally conductive path for greater thermal energy flux to the cooling fins 604 and, therefore, an increased capacity to remove heat from the vehicle pad 404. In some implementations, the vehicle pad 404 further includes a heat spreader 622 configured to make physical contact with the capacitors 618 and transfer heat generated in the capacitors 618 to the primary heat sink 602. The heat spreader 622 may comprise a metallic or other highly thermally conductive material. Similarly, in some implementations, the vehicle pad 404 further includes a diode cover 624 configured to make physical contact with the diodes 620 and transfer heat generated in the diodes 620 to the primary heat sink 602. The diode cover 624 may comprise a metallic or other highly thermally conductive material. The vehicle pad 404 may further comprise a secondary heat sink 626 configured to cover the electrical components within the recessed portion 606 and, in some implementations, to make physical contact with one or both of the heat spreader 622 and the diode cover 624 in order to provide a high thermal conductivity path from the capacitors 618 and the diodes 620 to the primary heat sink 602.

The recessed portion 606 may be at least partially sealed from the external environment using a seal 628 between at least portions of the primary heat sink 602 and the secondary heat sink 626. In implementations not including the secondary heat sink 626, the heat spreader 622 and the diode cover 624 may make direct physical contact with the primary heat sink 602.

On a reverse side of the primary heat sink 602, a ferrite structure 608 may be disposed adjacent to, and in some implementations in physical or thermal contact with, the primary heat sink 602. The term “thermal contact” may be defined as direct physical contact or, alternatively, direct physical contact with an electrically insulating material that is in direct physical contact with the primary heat sink 602. Likewise, “thermally connecting” may be defined as being in physical contact such that a physical path is formed through which thermal energy may be transferred. Thus, although the ferrite structure 608 may not be in direct physical contact with the primary heat sink 602, the ferrite structure 608 is in thermal contact in so far as there is a direct physical path between the primary heat sink 602 and the ferrite structure that is thermally conductive but not electrically conductive. In some implementations, the ferrite structure 608 may comprise a plurality of ferrite tiles. In some other implementations, the ferrite structure 608 may comprise a unitary piece of ferrite.

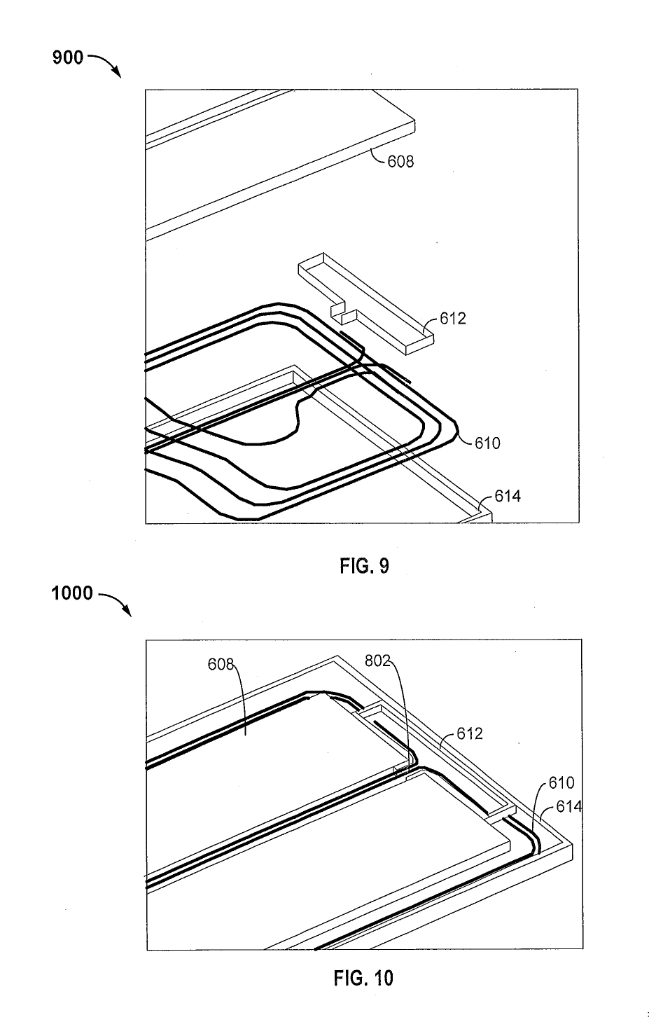

A conductor 610 (e.g., Litz wire) may be wound to form one or more receive coils and may be disposed adjacent to, and in some implementations under, the ferrite structure 608. As will be shown in more detail in connection with FIGS. 9 and 10, the conductor 610 may be terminated at a Litz wire termination socket 612. The Litz wire termination socket 612 may be disposed at least partially within the recessed portion 606 of the primary heat sink 602 through a hole 630 in the recessed portion 606 of the primary heat sink 602. This arrangement provides both a fixed position for ends of the conductor 610 and the termination socket 612 with respect to the PCB 616 as well as providing another short, high thermal conductivity path for heat generated in the conductor 610 to be channeled to the primary heat sink 602 for subsequent dissipation to the external environment. The termination socket 612 may also be physically mounted to a cover 614, which may be mounted to the bottom of the vehicle pad 404 via the primary heat sink 602. The termination socket 612 and conductor 610 may be shown in more detail in connection with FIGS. 9 and 10.

In some implementations, the cover 614 may further include a plurality of guides or ridges along which the conductor 610 may be fitted and wound to form the one or more receive coils. The cover 614 may comprise plastic. In some implementations, the vehicle pad 404 may have a length of 640 mm, a width of 312 mm and a thickness of just 28 mm, although any other dimensions are also contemplated.

In some implementations, the vehicle pad 404 may be configured to receive approximately 10 kW of power. In such implementations, a proportional amount of power (e.g., ˜180 W) may be lost in the form of heat in various portions of the vehicle pad 404. The components of the vehicle pad 404 will heat up due to power lost to internal resistances of the components. The present disclosure contemplates a vehicle pad 404 design that has an improved thermal energy dissipation capacity over previous designs without the need for forced cooling, fans, or significant air flow over the vehicle pad 404 as when the vehicle 112 is stationary over the base pad 402 (see FIG. 4), as well as when the vehicle 112 is moving along the power backbone 502 (see FIG. 5). Thus, in some implementations the plurality of fins 604 dissipate a greater amount of heat when the vehicle pad 404 wirelessly receives charging power while in motion than while stationary.

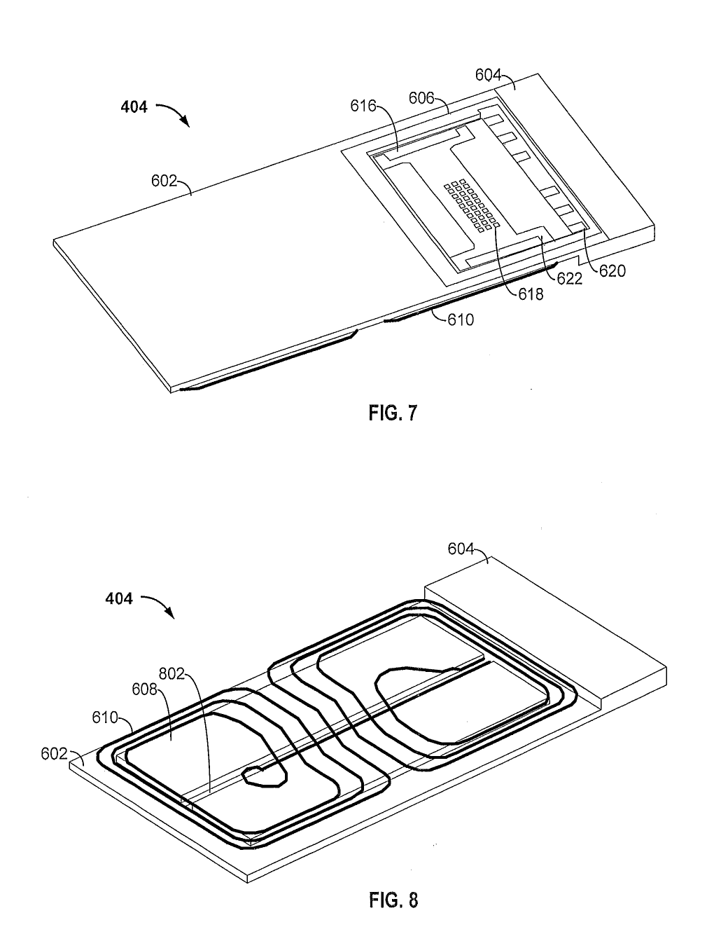

FIG. 7 is an isometric top view of the vehicle pad 404 of FIG. 6. FIG. 7 illustrates one embodiment of how the components of the vehicle pad 404 are assembled. For example, the PCB 616, including the capacitors 618 and diodes 620, is disposed in the recessed portion 606 of the primary heat sink 602. The diodes 620 are disposed adjacent to the cooling fins 604 of the primary heat sink 602 in order to provide as short a thermal path as possible to the cooling fins 604 to increase cooling efficiency. In some implementations, the diodes 620 are physically mounted directly to the primary heat sink 602 in the recessed portion 606 and may be electrically connected to the PCB 616. Such implementations would enjoy further increased rates of removal of thermal energy from the diodes 620 to the external environment through the primary heat sink 602 and the cooling fins 604. FIG. 7 further shows the heat spreader 622 disposed over or on the capacitors 618. FIG. 7 further shows the conductor 610 disposed under the primary heat sink 602. The ferrite structure 608 is not visible in FIG. 7 as it is hidden by the primary heat sink 602.

FIG. 8 is an isometric bottom view of the vehicle pad 404 of FIG. 6. FIG. 8 shows the primary heat sink 602 and the ferrite structure 608 disposed on, over, or under that primary heat sink 602, depending upon the orientation. The conductor 610, wound to form the one or more receive coils, is disposed on, over or under the ferrite structure 608, depending upon the orientation. In some implementations, the ferrite structure 608 may include a gap 802 for routing the conductor 610 to the Litz wire termination socket 612 (see FIGS. 9 and 10). In some implementations, the gap 802 may extend along an entire dimension of the ferrite structure 608.

FIG. 9 is an exploded isometric diagram of a portion of the vehicle pad 404 of FIG. 6 showing a Litz wire termination socket 612 configured to dissipate increased levels of thermal energy, in accordance with some implementations. FIG. 9 shows the cover 614, the conductor 610, the Litz wire termination socket 612, and the ferrite structure 608. The Litz wire termination socket 612 is configured to receive and secure the ends of the conductor 610 in a fixed location.

FIG. 10 is an isometric diagram of the portion of the vehicle pad 404 of FIG. 6 shown in FIG. 9 in an assembled state. FIG. 10 shows the cover 614, the conductor 610, the Litz wire termination socket 612, and the ferrite structure 608 in an assembled state. As shown, at least a portion of the conductor 610 is disposed in the gap 802 defined in the ferrite structure. The Litz wire termination socket 612 is disposed adjacent to the ferrite structure 608 and has at least a portion shaped and dimensioned to extend or fit in the gap 802 at an edge of the ferrite structure 608. This provides several dimensions of physical restriction for the location of the Litz wire termination socket 612. The Litz wire termination socket 612 connects the conductor 610 to the power electronics on the PCB 616.

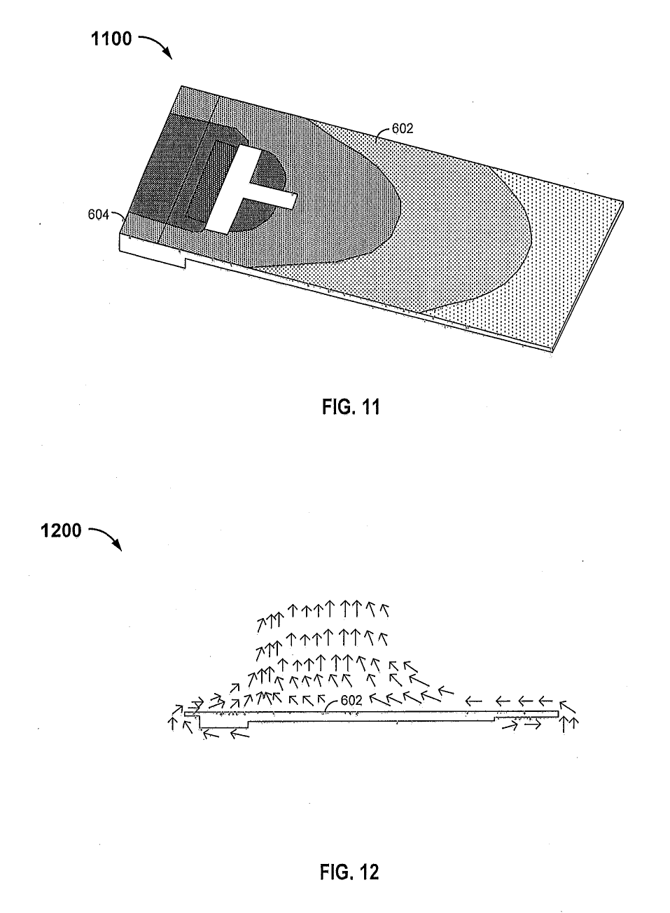

FIG. 11 is a thermal contour diagram 1100 of the primary heat sink 602 of the vehicle pad 404 of FIG. 6 during operation, in accordance with some implementations. As shown, utilizing certain embodiments of the vehicle pad 404, having the features as previously described in connection with FIGS. 6-10, allows the vehicle pad 404 to receive wireless power (e.g., approximately 10 kW) at ambient temperatures of 20° C. while maintaining a maximum temperature of approximately 65° C. Relative temperatures are shown by shading, wherein the darker the shading the higher the relative temperature. As shown, the highest temperatures are located at or near the locations where the diodes 620 are mounted (e.g., near the opening shown without shading) and temperatures drop as the location moves away from the highest temperatures and toward the end of the primary heat sink 602 opposite the cooling fins 604. Thus, having the cooling fins 604 as near as possible or practical to the diodes 620 and/or the recessed portion 606 provides the shortest path for thermal energy to dissipate.

FIG. 12 is a diagram 1200 illustrating air velocity around the primary heat sink 602 of the vehicle pad 404 of FIG. 6 during operation, in accordance with some implementations. As shown, there is substantially no air movement in the air volume located laterally to the primary heat sink 602. The air volume just under the primary heat sink 602 has a small amount of air movement, in the velocities of 0.03 to 0.09 meters per second, which may be largely due to heated air flowing along the bottom surface of the primary heat sink 602 and then rising once around the edge of the primary heat sink 602. Air flow becomes substantially vertical and has an increased velocity in volumes above the portions of the primary heat sink 602 where the highest heat generating components (e.g., the diodes 620 and capacitors 618 (not shown in FIG. 12) are located. Such substantially vertical air velocities may range from approximately 0.10 to 0.22 meters per second and are largely due to heated air rising directly from near the top surface of the primary heat sink 602, where higher primary heat sink 602 temperatures correspond to higher air velocities. This phenomenon may be due to both the proportion of added thermal (e.g., kinetic) energy carried by the hotter air, as well as by the increased buoyancy of hotter air being less dense than the cooler air. Concentration of the cooling fins 604 as near as possible or practical to the portions of the primary heat sink 602 that get the hottest increases the amount of thermal energy that can be imparted to the surrounding air, raising its velocity of ascent, and thereby increasing the amount of convective cooling taking place.

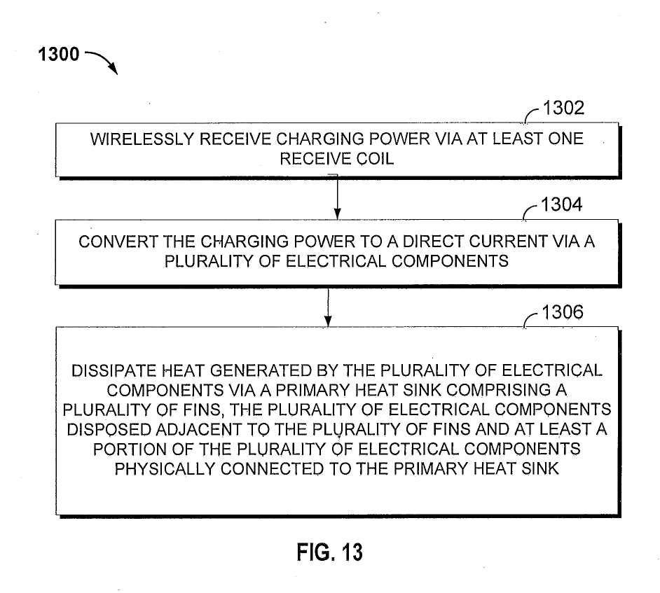

FIG. 13 is a flowchart 1300 depicting a method for wirelessly receiving charging power, in accordance with some implementations. The method of flowchart 1300 is described herein with reference to any of FIGS. 4-12. Although the method of flowchart 1300 is described herein with reference to a particular order, in various implementations, blocks herein may be performed in a different order or omitted, and additional blocks may be added.

The flowchart 1300 may start with block 1302, which includes wirelessly receiving charging power via at least one receive coil. For example, the conductor 610 of FIG. 6 is wound to form at least one receive coil. That at least one receive coil is configured to wirelessly receive charging power (e.g., 10 kW).

The flowchart 1300 may then advance to block 1304, which includes converting the charging power to a direct current via a plurality of electrical components. For example, the capacitors 618 and/or the diodes 620 may comprise a plurality of electrical components that, when arranged in at least a rectification circuit, are configured to convert the charging power received by the at least one receive coil, comprising the conductor 610, to a direct current.

The flowchart 1300 may then advance to block 1306, which includes dissipating heat generated by the plurality of electrical components via a primary heat sink comprising a plurality of fins. The plurality of electrical components are disposed adjacent to the plurality of fins and at least some of the plurality of electrical components are physically connected to the primary heat sink 602. For example, the diodes 620 and/or the capacitors 618 generate heat during operation that is dissipated by the primary heat sink 602 and the plurality of fins 604, that is disposed adjacent to the diodes 620 and/or the capacitors 618. Moreover, in some implementations, the diodes 620 may be physically connected to the primary heat sink 602 in order to increase the amount of heat that can be transferred to the primary heat sink 602 in a given amount of time.

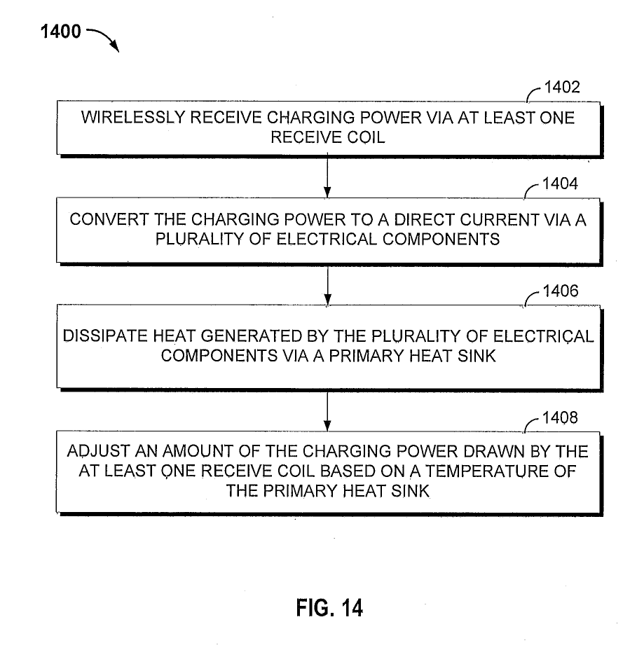

FIG. 14 is a flowchart 1400 depicting another method for wirelessly receiving charging power at a vehicle, in accordance with some implementations. The method of flowchart 1400 is described herein with reference to any of FIGS. 4-12. Although the method of flowchart 1400 is described herein with reference to a particular order, in various implementations, blocks herein may be performed in a different order or omitted, and additional blocks may be added.

The flowchart 1400 may start with block 1402, which includes wirelessly receiving charging power via at least one receive coil. For example, the conductor 610 of FIG. 6 is wound to form at least one receive coil. The at least one receive coil is configured to wirelessly receive charging power (e.g., 10 kW). In some implementations, the conductor 610 of FIG. 6 may also be known as, or comprise at least a portion of “means for wirelessly receiving charging power.”

The flowchart 1400 may then advance to block 1404, which includes converting the charging power to a direct current via a plurality of electrical components. For example, the capacitors 618 and/or the diodes 620 may comprise a plurality of electrical components that, when arranged in at least a rectification circuit, are configured to convert the charging power received by the at least one receive coil, comprising the conductor 610, to a direct current. In some implementations, the capacitors and/or the diodes 620 may also be known as, or comprise at least a portion of “means for converting the charging power to a direct current.”

The flowchart 1400 may then advance to block 1406, which includes dissipating heat generated by the plurality of electrical components via a primary heat sink 602 comprising a plurality of fins. For example, the diodes 620 and/or the capacitors 618 generate heat during operation that is dissipated by the primary heat sink 602 and the plurality of fins 604. In some implementations, the plurality of fins 504 may be disposed adjacent to the diodes 620 and/or the capacitors 618. Moreover, in some implementations, the diodes 620 may be physically connected to the primary heat sink 602 in order to increase the amount of heat that can be transferred to the primary heat sink 602 in a given amount of time. In some implementations, the primary heat sink 602 may also be known as or comprise at least a portion of “means for dissipating heat.”

The flowchart 1400 may then advance to block 1408, which includes adjusting an amount of the charging power drawn by the at least one receive coil based on a temperature of the primary heat sink 602. For example, a controller (e.g., the electric vehicle controller 344 of FIG. 3) may be configured to adjust an amount of the charging power drawn by the at least one receive coil (e.g., the conductor 610 of FIG. 6) based on a temperature of the primary heat sink 602. Specifically, the diodes 620 and/or the capacitors 618 generate heat during operation that is dissipated by the primary heat sink 602 and the plurality of fins 604. In some implementations, the diodes 620 and/or the capacitors 618 may operate most effectively below some temperature threshold (e.g., 65° C.). In some implementations, a controller (e.g., the electric vehicle controller 344 of FIG. 3) may also be known as, or comprise at least a portion of “means for adjusting an amount of the charging power drawn by the means for wirelessly receiving charging power.”

In some implementations, in order to ensure these components do not exceed such a temperature threshold, the flowchart 1400 may additionally include (not shown) disabling the wirelessly receiving the charging power via the at least one receive coil based on the temperature of the primary heat sink 602 satisfying a threshold value. For example, the controller (e.g., the electric vehicle controller 344 of FIG. 3) may be configured to disable the at least one receive coil (e.g., the conductor 610 of FIG. 6) from receiving the charging power based on the temperature of the primary heat sink 602 satisfying a threshold value. In some implementations, the controller (e.g., the electric vehicle controller 344 of FIG. 3) may also be known as or comprise at least a portion of “means for disabling the wirelessly receiving the charging power.”

In some other implementations, the flowchart 1400 may additionally include (not shown) adjusting the amount of the charging power drawn by the at least one receive coil based on whether the vehicle is in motion. For example, the controller (e.g., the electric vehicle controller 344 of FIG. 3) may be configured to adjust the amount of the charging power drawn by the at least one receive coil based on whether the vehicle is in motion. In some implementations, the controller (e.g., the electric vehicle controller 344 of FIG. 3) may also be known as or comprise at least a portion of “means for adjusting the amount of the charging power drawn by the at least one receive coil based on whether the vehicle is in motion.”

In some other implementations, the flowchart 1400 may additionally include (not shown) adjusting the amount of the charging power drawn by the at least one receive coil based on an identifier of a wireless power transmitter transmitting the charging power. For example, a controller (e.g., the electric vehicle controller 344 of FIG. 3) may be configured to adjust the amount of the charging power drawn by the at least one receive coil based on an identifier of a wireless power transmitter transmitting the charging power. In some implementations, the controller (e.g., the electric vehicle controller 344 of FIG. 3) may also be known as or comprise at least a portion of “means for adjusting the amount of the charging power drawn by the at least one receive coil based on an identifier of a wireless power transmitter transmitting the charging power.”

In some other implementations, the flowchart 1400 may additionally include (not shown) adjusting the amount of the charging power drawn by the at least one receive coil based on a configurability of a wireless power transmitter to transmit the charging power to the vehicle while the vehicle is in motion. For example, a controller (e.g., the electric vehicle controller 344 of FIG. 3) may be configured to adjust the amount of the charging power drawn by the at least one receive coil based on a configurability of a wireless power transmitter to transmit the charging power to the vehicle while the vehicle is in motion. In some implementations, the controller (e.g., the electric vehicle controller 344 of FIG. 3) may also be known as or comprise at least a portion of “means for adjusting the amount of the charging power drawn by the at least one receive coil based on a configurability of a wireless power transmitter to transmit the charging power to the vehicle while the vehicle is in motion.”

In some other implementations, the flowchart 1400 may additionally include (not shown) adjusting the amount of the charging power drawn by the at least one receive coil from a first value for a first interval of time to a second value lower than the first value after the first interval of time. For example, a controller (e.g., the electric vehicle controller 344 of FIG. 3) may be configured to adjust the amount of the charging power drawn by the at least one receive coil from a first value for a first interval of time to a second value lower than the first value after the first interval of time. In some implementations, the controller (e.g., the electric vehicle controller 344 of FIG. 3) may also be known as or comprise at least a portion of “means for adjusting the amount of the charging power drawn by the at least one receive coil from a first value for a first interval of time to a second value lower than the first value after the first interval of time.”

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, means for wirelessly receive charging power may comprise the receive coil formed from the conductor 610, as previously described in connection with FIG. 6, and may function as previously described in connection with FIGS. 1-3. The plurality of means for converting the charging power to a direct current may comprise some or all of the capacitors 618 and/or the diodes 620 and may function as conventional rectification and/or resonance circuits function. Means for dissipating heat may comprise the primary heat sink 602 and may further include the plurality of fins 604. Means for thermally connecting may comprise either or both of the heat spreader 622 or the diode cover 624 and may function as previously described in connection with FIGS. 6-7.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory, computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media.

For purposes of summarizing the disclosure, certain aspects, advantages and novel features of the implementations have been described herein. It is to be understood that not necessarily all such advantages may be achieved in accordance with any particular implementation. Thus, the implementations may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the present application. Thus, the present application is not intended to be limited to the implementations shown herein but is to be accorded the widest scope consistent with the principles and novel features disclosed herein.

What is claimed is:

1. An apparatus for wirelessly receiving charging power, the apparatus comprising:
at least one receive coil configured to wirelessly receive the charging power;
a plurality of electrical components configured to convert the charging power to a direct current;
a primary heat sink comprising a plurality of fins configured to dissipate heat generated by the plurality of electrical components, the plurality of fins disposed adjacent to the plurality of electrical components; and
at least one thermally conductive structure configured to physically connect at least some of the plurality of electrical components to the primary heat sink.

2. The apparatus of claim 1, wherein the primary heat sink comprises a recessed portion configured to support the plurality of electrical components.

3. The apparatus of claim 2, further comprising a secondary heat sink configured to cover the recessed portion and thermally connect the at least one thermally conductive structure to the primary heat sink.

4. The apparatus of claim 2, wherein the recessed portion defines a hole configured to accommodate a termination socket configured to receive ends of the at least one receive coil and electrically connect the at least one receive coil to at least some of the plurality of electrical components.

5. The apparatus of claim 1, wherein at least some of the plurality of electrical components are directly physically mounted to the primary heat sink.

6. The apparatus of claim 1, wherein the plurality of fins dissipate a greater amount of heat when the apparatus wirelessly receives the charging power while in motion than while stationary.

7. The apparatus of claim 1, wherein at least some of the plurality of electrical components comprise capacitors and the at least one thermally conductive structure comprises a heat spreader thermally connecting the capacitors to the primary heat sink.

8. The apparatus of claim 1, wherein at least some of the plurality of electrical components comprise diodes and the at least one thermally conductive structure comprises a diode cover thermally connecting the diodes to the primary heat sink.

9. The apparatus of claim 1, further comprising a ferrite structure in thermal contact with the primary heat sink.

10. A method for wirelessly receiving charging power, the method comprising:
wirelessly receiving the charging power via at least one receive coil,
converting the charging power to a direct current via a plurality of electrical components, and
dissipating heat generated by the plurality of electrical components via a primary heat sink comprising a plurality of fins, the plurality of electrical components disposed adjacent to the plurality of fins and at least some of the plurality of electrical components physically connected to the primary heat sink.

11. The method of claim 10, wherein the primary heat sink comprises a recessed portion configured to support the plurality of electrical components.

12. The method of claim 10, wherein at least one thermally conductive structure is thermally connected to the primary heat sink via a secondary heat sink.

13. The method of claim 11, wherein the recessed portion defines a hole configured to accommodate a termination socket configured to receive ends of the at least one receive coil and electrically connect the at least one receive coil to at least some of the plurality of electrical components.

14. The method of claim 10, wherein at least some of the plurality of electrical components are directly physically mounted to the primary heat sink.

15. The method of claim 10, further comprising dissipating a greater amount of heat via the plurality of fins when wirelessly receiving the charging power while in motion than while stationary.

16. The method of claim 10, wherein at least some of the plurality of electrical components comprise capacitors and a heat spreader thermally connects the capacitors to the primary heat sink.

17. The method of claim 10, wherein at least some of the plurality of electrical components comprise diodes and a diode cover thermally connects the diodes to the primary heat sink.

18. An apparatus for wirelessly receiving charging power on a vehicle, the apparatus comprising:
at least one receive coil configured to wirelessly receive the charging power;
a plurality of electrical components configured to convert the charging power to a direct current;
a primary heat sink configured to dissipate heat generated by the plurality of electrical components; and
a controller configured to adjust an amount of the charging power drawn by the at least one receive coil based on a temperature of the primary heat sink.

19. The apparatus of claim 18, wherein the controller is configured to disable the at least one receive coil from receiving the charging power based on the temperature of the primary heat sink.

20. The apparatus of claim 18, wherein the controller is further configured to adjust the amount of the charging power drawn by the at least one receive coil based on whether the vehicle is in motion.

21. The apparatus of claim 18, wherein the controller is further configured to adjust the amount of the charging power drawn by the at least one receive coil based on an identifier of a wireless power transmitter transmitting the charging power.

22. The apparatus of claim 18, wherein the controller is further configured to adjust the amount of the charging power drawn by the at least one receive coil based on a configurability of a wireless power transmitter to transmit the charging power to the vehicle while the vehicle is in motion.

23. The apparatus of claim 18, wherein the controller is further configured to adjust the amount of the charging power drawn by the at least one receive coil from a first value for a first interval of time to a second value lower than the first value after the first interval of time.

24. A method for wirelessly receiving charging power at a vehicle, the method comprising:
wirelessly receiving the charging power via at least one receive coil;
converting the charging power to a direct current via a plurality of electrical components;
dissipating heat generated by the plurality of electrical components via a primary heat sink; and
adjusting an amount of the charging power drawn by the at least one receive coil based on a temperature of the primary heat sink.

25. The method of claim 24, further comprising disabling the wirelessly receiving the charging power via the at least one receive coil based on the temperature of the primary heat sink.

26. The method of claim 24, further comprising adjusting the amount of the charging power drawn by the at least one receive coil based on whether the vehicle is in motion.

27. The method of claim 24, further comprising adjusting the amount of the charging power drawn by the at least one receive coil based on an identifier of a wireless power transmitter transmitting the charging power.

28. The method of claim 24, further comprising adjusting the amount of the charging power drawn by the at least one receive coil based on a configurability of a wireless power transmitter to transmit the charging power to the vehicle while the vehicle is in motion.

29. The method of claim 24, further comprising adjusting the amount of the charging power drawn by the at least one receive coil from a first value for a first interval of time to a second value lower than the first value after the first interval of time.
